(19) United States
(12) Patent Application Publication
(10) Pub. No.: US 2018/0053120 A1
(43) Pub. Date: Feb. 22, 2018

(54) SYSTEM AND METHOD FOR IDENTIFYING A SUBSET OF TOTAL HISTORICAL USERS OF A DOCUMENT PREPARATION SYSTEM TO REPRESENT A FULL SET OF TEST SCENARIOS BASED ON STATISTICAL ANALYSIS

(71) Applicant: Intuit Inc., Mountain View, CA (US)

(72) Inventors: Saikat Mukherjee, Fremont, CA (US); Saneesh Joseph, San Diego, CA (US); Cem Unsal, Alameda, CA (US)

(73) Assignee: Intuit Inc., Mountain View, CA (US)

(21) Appl. No.: 15/796,419

(22) Filed: Oct. 27, 2017

Related U.S. Application Data
(63) Continuation-in-part of application No. 15/292,510, filed on Oct. 13, 2016.
(60) Provisional application No. 62/362,688, filed on Jul. 15, 2016.

(51) Int. Cl. G06N 99/00; G06Q 40/00; G06N 5/02

(52) U.S. Cl. CPC G06N 99/005; G06N 5/02; G06Q 40/123

(57) ABSTRACT

A method and system generate sample data set for efficiently and accurately testing a new calculation for preparing a portion of an electronic document for users of an electronic document preparation system. The method and system receive the new calculation and gather historical use data related to previously prepared electronic documents for a large number of historical users. The method and system group the historical users into groups based on the attributes of the historical users. The groups are selected to include groups dedicated to users with rare combinations of attributes, as well as groups for users with more common combinations of attributes. The groups are then sampled by selecting a small number of historical users from each group.

### RELATED CASE

The present application is a continuation in part of co-pending U.S. patent application Ser. No. 15/292,510, filed Oct. 13, 2016 having attorney docket number INTU179969, and titled SYSTEM AND METHOD FOR SELECTING DATA SAMPLE GROUPS FOR MACHINE LEARNING OF CONTEXT OF DATA FIELDS FOR VARIOUS DOCUMENT TYPES AND/OR FOR TEST DATA GENERATION FOR QUALITY ASSURANCE SYSTEMS. U.S. patent application Ser. No. 15/292,510 claims priority benefit from U.S. Provisional Patent Application No. 62/362,688, filed Jul. 15, 2016 having attorney docket number INTU169813, and titled SYSTEM AND METHOD FOR MACHINE LEARNING OF CONTEXT OF LINE INSTRUCTIONS FOR VARIOUS DOCUMENT TYPES. U.S. patent application Ser. No. 15/292,510 and U.S. Provisional Patent Application No. 62/362,688 are incorporated herein by reference in their entireties.

### BACKGROUND

Many people use electronic document preparation systems to help prepare important documents electronically. For example, each year millions of people use tax return preparation systems to help prepare and file their tax returns. Typically, tax return preparation systems receive tax related information from a user and then automatically populate the various fields in electronic versions of government tax forms. Tax return preparation systems represent a potentially flexible, highly accessible, and affordable source of tax return preparation assistance for customers.

The processes that enable the electronic tax return preparation systems to prepare tax returns for users are highly complex and often utilize large amounts of human and computing resources. To reduce the usage of computing and human resources, new tax return preparation processes are continually being developed. Of course, before the new tax return preparation processes can be implemented, they must be thoroughly tested to ensure that they properly calculate data values for tax returns. However, testing the new processes with a very large number of previous tax filers results in a very high use of computing and human resources in the testing process. On the other hand, testing the new processes with a smaller random sample of previous tax filers is often inadequate, as less common tax filer attributes will likely not appear in the sample set. If the new processes are not tested to ensure that the processes can accurately handle tax filers with uncommon attributes, then flaws in the new processes will likely go undetected. This results in the tax return preparation system failing to properly prepare the tax returns for many users.

In addition, lengthy and resource intensive testing processes can lead to delays in releasing an updated version of the electronic tax return preparation system as well as considerable expense. This expense is then passed on to customers of the electronic tax return preparation system. These expenses, delays, and possible inaccuracies often have an adverse impact on traditional electronic tax return preparation systems.

These issues and drawbacks are not limited to electronic tax return preparation systems. Any electronic document preparation system that assists users to electronically fill out forms or prepare documents can suffer from these drawbacks when new processes are developed for preparing the documents.

What is needed is a method and system that provides a technical solution to the technical problem of generating sample data sets that are sure to cover all use cases while efficiently using resources.

### SUMMARY

Embodiments of the present disclosure provide one or more technical solutions to the technical problem of electronic document preparation systems that are not able to generate sample data sets that are sure to cover all use cases while efficiently using resources. The technical solutions include generating training sets for testing new calculations with very small sample sizes that, nevertheless, result in representation of the entire range of possible users. The training set data includes previously prepared electronic documents associated with a relatively small number of historical users of an electronic document preparation system. Embodiments of the present disclosure generate the training set data by generating bin data. The bin data includes, for each variable associated with a new calculation, a plurality of bins. For each variable, each historical user is sorted into one of the bins based on the data value that the historical user has for the variable. Embodiments of the present disclosure generate grouping data that includes a group for each combination of bins represented among the historical users. Thus, embodiments of the present disclosure generate the grouping data such that, if a small number of historical users is taken from each group, these historical users will represent all types of historical users, including historical users with rare or uncommon attributes.

Embodiments of the present disclosure overcome the drawbacks of traditional electronic document preparation systems that generate training set data by taking a random sample of the entire group of historical users, resulting in the high likelihood that historical users with very rare combinations of attributes will not be present in the training set data. Embodiments of the present disclosure also overcome the drawbacks of traditional electronic document preparation systems that generate training set data including a very large number of historical users in order to increase the likelihood that historical users with rare attributes will be represented. Embodiments of the present disclosure overcome these drawbacks by providing a very small sample of historical users that will include all types of historical users.

### BRIEF DESCRIPTION OF THE DRAWINGS

FIG. 1 is a block diagram of software architecture for generating efficient training sets for testing new processes for preparing electronic documents for users of an electronic document preparation system, in accordance with one embodiment.

FIG. 2 is a block diagram of a process for generating bin data as part of a process for generating efficient training sets for testing new processes for preparing electronic documents for users of an electronic document preparation system, in accordance with one embodiment.

FIG. 3 is a block diagram of a process for generating efficient training sets for testing new processes for preparing electronic documents for users of an electronic document preparation system, in accordance with one embodiment.

FIG. 4 is a flow diagram of a process for generating efficient training sets for testing new processes for preparing electronic documents for users of an electronic document preparation system, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and described below. Rather, these exemplary embodiments are provided to allow a complete disclosure that conveys the principles of the invention, as set forth in the claims, to those of skill in the art.

Herein, the term “production environment” includes the various components, or assets, used to deploy, implement, access, and use, a given application as that application is intended to be used. In various embodiments, production environments include multiple assets that are combined, communicatively coupled, virtually connected, physically connected, or otherwise associated with one another, to provide the production environment implementing the application.

As specific illustrative examples, the assets making up a given production environment can include, but are not limited to, one or more computing environments used to implement the application in the production environment such as one or more of a data center, a cloud computing environment, a dedicated hosting environment, and other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control one or more assets or components of the production environment; one or more communications channels for sending and receiving data used to implement the application in the production environment; one or more access control systems for limiting access to various components of the production environment, such as firewalls and gateways; one or more traffic or routing systems used to direct, control, or buffer, data traffic to components of the production environment, such as routers and switches; one or more communications endpoint proxy systems used to buffer, process, or direct data traffic, such as load balancers or buffers; one or more secure communication protocols or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; or any other assets/components making up an actual production environment in which an application is deployed, implemented, accessed, and run, e.g., operated, as discussed herein, or as known in the art at the time of filing, or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes or operations as described herein.

As used herein, the term “computing environment” includes, but is not limited to, a logical or physical grouping of connected or networked computing systems or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems or virtual assets making up the trusted computing environment, are either under the control of, or known to, a party.

In various embodiments, each computing environment includes allocated assets and virtual assets associated with, and controlled or used to create, deploy, or operate an application.

In various embodiments, one or more cloud computing environments are used to create, deploy, or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, or as known in the art at the time of filing, or as developed after the time of filing.

In many cases, a given application or service may utilize, and interface with, multiple cloud computing environments, such as multiple VPCs, in the course of being created, deployed, or operated.

As used herein, the term “virtual asset” includes any virtualized entity or resource or virtualized part of an actual “bare metal” entity. In various embodiments, the virtual assets can be, but are not limited to, virtual machines, virtual servers, and instances implemented in a cloud computing environment; databases associated with a cloud computing environment, or implemented in a cloud computing environment; services associated with, or delivered through, a cloud computing environment; communications systems used with, part of, or provided through, a cloud computing environment; or any other virtualized assets or sub-systems of “bare metal” physical devices such as mobile devices, remote sensors, laptops, desktops, point-of-sale devices, etc., located within a data center, within a cloud computing environment, or any other physical or logical location, as discussed herein, or as known/available in the art at the time of filing, or as developed/made available after the time of filing.

In various embodiments, any, or all, of the assets making up a given production environment discussed herein, or as known in the art at the time of filing, or as developed after the time of filing, can be implemented as one or more virtual assets.

In one embodiment, two or more assets, such as computing systems or virtual assets, two or more computing environments, are connected by one or more communications channels including but not limited to, Secure Sockets Layer communications channels and various other secure communications channels, or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, or virtual assets, as discussed herein, or available or known at the time of filing, or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, or computing systems, whether available or known at the time of filing or as later developed.

As used herein, the term “user” includes, but is not limited to, any party, parties, entity, or entities using, or otherwise interacting with any of the methods or systems discussed herein. For instance, in various embodiments, a user can be, but is not limited to, a person, a commercial entity, an application, a service, or a computing system.

As used herein, the term “relationship(s)” includes, but is not limited to, a logical, mathematical, statistical, or other association between one set or group of information, data, or users and another set or group of information, data, or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed electronic document preparation system determines a relationship between a first group of data and a second group of data, then a characteristic or subset of a first group of data can be related to, associated with, or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

In one embodiment, an electronic document preparation system generates the grouping data based on analysis of the attributes of the historical users. When new calculation data, representing a calculation or process for generating one or more data values for an electronic document, is to be tested by the electronic document preparation system, the electronic document preparation system identifies variable data associated with the new calculation data. The variable data corresponds to the variables that are associated with the calculation or process for generating the one or more data values for the electronic document. The electronic document preparation system analyzes the historical user data to determine, for each variable, the data value each historical user has for the variable. The electronic document preparation system generates the grouping data based on the combinations of data values that the historical users have for the variables. The electronic document preparation system generates the grouping data to include groups dedicated to rare combinations of data values and to include groups dedicated to more common combinations of data values.

In one embodiment, the electronic document preparation system generates the grouping data based on bin data related to the variable data. The electronic document preparation system generates, for each variable associated with the calculation, a plurality of bins. Each bin corresponds to a data value or range of data values represented in the historical user data for that variable. For each variable, each historical user is sorted into one of the bins based on the data value that the historical user has for the variable. Thus, each historical user is represented by a combination of bins into which the historical user has been sorted for the plurality of variables associated with the new calculation data. The bins are selected for each variable to ensure that there are bins for rare data values and for common data values. The electronic document preparation system generates the grouping data by generating a group for each combination of bins represented by the historical users. Thus, the grouping data will include a group for each rare combination of bins and for each more common combination of bins. Sampling a small number of historical users from each group will therefore result in a training set that covers all combinations of attributes.

In one embodiment, the electronic document preparation system is a tax return preparation system. The historical user data corresponds to previously prepared tax returns for a large number of historical users of the tax return preparation system. The new calculation data to be tested corresponds to a calculation for populating a tax related form associated with preparing a tax return. The variables associated with the calculation can include tax related attributes such as, but not limited to, home ownership status, marital status, W-2 income, an employer's address, spousal information, children's information, asset information, medical history, occupation, information regarding dependents, salary and wages, interest income, dividend income, business income, farm income, capital gain income, pension income, IRA distributions, education expenses, health savings account deductions, moving expenses, IRA deductions, student loan interest, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, an employer identification number (EID), a job title, annual income, salary and wages, bonuses, a Social Security number, a government identification, a driver's license number, a date of birth, an address, a zip code. The tax return preparation system can generate grouping data based on the data values that the historical users have for the various tax related variables. In particular, the tax return preparation system can generate grouping data based on the combinations of data values that the historical users have for the tax related variables.

In one embodiment, the electronic document preparation system can include a financial document preparation system other than a tax return preparation system.

Embodiments of the present disclosure address some of the shortcomings associated with traditional electronic document preparation systems that generate training sets that are highly inefficient and inaccurate. An electronic document preparation system in accordance with one or more embodiments provides training sets that are very small in size and that nevertheless provide for accurate testing because they cover the entire range of historical users. The various embodiments of the disclosure can be implemented to improve the technical fields of data processing, electronic document preparation, data transmission, data analysis, and data collection. Therefore, the various described embodiments of the disclosure and their associated benefits amount to significantly more than an abstract idea. In particular, by generating efficient training sets for testing new processes for preparing electronic documents for users of an electronic document preparation system, the electronic document preparation system can learn and incorporate new forms more efficiently.

Using the disclosed embodiments of a method and system for generating efficient training sets for testing new processes for preparing electronic documents for users of an electronic document preparation system, a method and system for generating efficient training sets for testing new processes for preparing electronic documents for users of an electronic document preparation system more accurately is provided. Therefore, the disclosed embodiments provide a technical solution to the long standing technical problem of efficiently and accurately testing new calculations or processes in an electronic document preparation system.

In addition, the disclosed embodiments of a method and system for generating efficient training sets for testing new processes for preparing electronic documents for users of an electronic document preparation system are also capable of dynamically adapting to constantly changing fields such as tax return preparation and other kinds of document preparation. Consequently, the disclosed embodiments of a method and system for generating efficient training sets for testing new processes for preparing electronic documents for users of an electronic document preparation system also provide a technical solution to the long standing technical problem of static and inflexible electronic document preparation systems.

The result is a much more accurate, adaptable, and robust method and system for generating efficient training sets for testing new processes for preparing electronic documents for users of an electronic document preparation system. This, in turn, results in: less human and processor resources being dedicated to analyzing new forms because more accurate and efficient analysis methods can be implemented, i.e., usage of fewer processing resources, usage of fewer memory storage assets, and less communication bandwidth being utilized to transmit data for analysis.

The disclosed method and system for generating efficient training sets for testing new processes for preparing electronic documents for users of an electronic document preparation system does not encompass, embody, or preclude other forms of innovation in the area of electronic document preparation systems. In addition, the disclosed method and system for generating efficient training sets for testing new processes for preparing electronic documents for users of an electronic document preparation system is not related to any fundamental economic practice, fundamental data processing practice, mental steps, or pen and paper based solutions, and is, in fact, directed to providing solutions to new and existing problems associated with electronic document preparation systems. Consequently, the disclosed method and system for generating efficient training sets for testing new processes for preparing electronic documents for users of an electronic document preparation system, does not encompass, and is not merely, an abstract idea or concept.

### Hardware Architecture

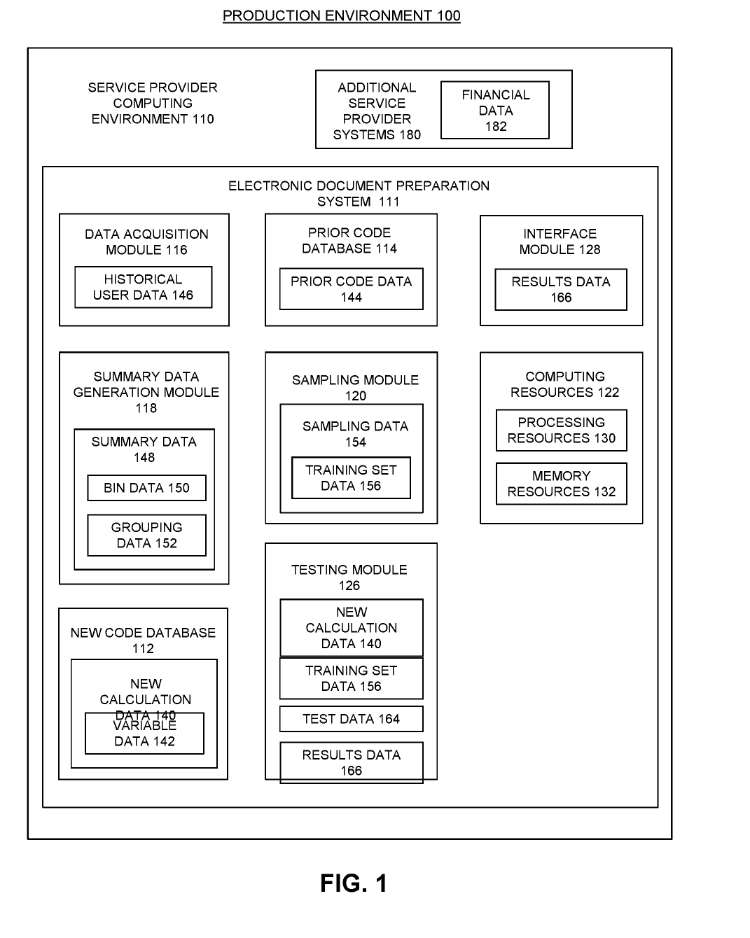

FIG. 1 illustrates a block diagram of a production environment 100 for generating efficient training sets for testing new processes for preparing electronic documents for users of an electronic document preparation system, according to one embodiment. Embodiments of the present disclosure provide methods and systems for generating efficient training sets for testing new processes for preparing electronic documents for users of an electronic document preparation system, according to one embodiment. In particular, embodiments of the present disclosure receive new calculation data corresponding to a new process for generating data values to populate an electronic form for users. In order to test the new calculation data, embodiments of the present disclosure retrieve historical user data that includes data related to a large number of historical users of the electronic document preparation system. Embodiments of the present disclosure generate grouping data that sorts the historical users into groups. The groups are selected such that sampling a relatively small number of historical users from each group results in a training set that represents the entire spectrum of historical users, including those with rare combinations of attributes. Embodiments of the present disclosure generate training set data by sampling a small number of historical users from each group in the grouping data. Embodiments of the present disclosure then test the calculation for each historical user from the training set. If the test indicates that the calculation is correct for the whole training set, then the calculation is reliable because it has been tested for the most common and the rarest types individuals. The result is a very efficient testing process because the training set includes a small number of historical users that is sure to represent the entire range of historical users.

In one embodiment, summary data identifies the variables associated with the calculation. Embodiments of the present disclosure analyze, for each variable, the distribution of data values for the various historical users. Embodiments of the present disclosure generate bin data that includes, for each variable, a plurality of bins based on the distribution of data values such that each historical user is sorted into one of the bins. The bins are chosen so that there will be bins that represent rare data values. Each historical user is represented by the combination of bins into which the historical user has been sorted based on the data values the historical user has for each variable. The grouping data includes a group for each unique combination of bins represented by one or more historical users. By sampling historical users from each group or bin combination, the training set data will reliably represent the entire spectrum of users while still being relatively small in size.

In addition, the disclosed method and system for generating efficient training sets for testing new processes for preparing electronic documents for users of an electronic document preparation system provides for significant improvements to the technical fields of electronic document preparation, data processing, data management, and user experience.

In addition, as discussed above, the disclosed method and system for generating efficient training sets for testing new processes for preparing electronic documents for users of an electronic document preparation system provide for the processing and storing of smaller amounts of data, i.e., more efficiently analyze forms and data; thereby eliminating unnecessary data analysis and storage. Consequently, using the disclosed method and system for generating efficient training sets for testing new processes for preparing electronic documents for users of an electronic document preparation system results in more efficient use of human and non-human resources, fewer processor cycles being utilized, reduced memory utilization, and less communications bandwidth being utilized to relay data to, and from, backend systems and client systems, and various investigative systems and parties. As a result, computing systems are transformed into faster, more efficient, and more effective computing systems by implementing the method and system for generating efficient training sets for testing new processes for preparing electronic documents for users of an electronic document preparation system.

Referring to FIG. 1, the production environment 100 includes a service provider computing environment 110 for generating efficient training sets for testing new processes for preparing electronic documents for users of an electronic document preparation system, according to one embodiment. The service provider computing environment 110 represents one or more computing systems such as one or more servers or distribution centers that are configured to receive, execute, and host one or more electronic document preparation systems (e.g., applications) for access by one or more users, for generating efficient training sets for testing new processes for preparing electronic documents for users of an electronic document preparation system, according to one embodiment. The service provider computing environment 110 can represent a traditional data center computing environment, a virtual asset computing environment (e.g., a cloud computing environment), a hybrid between a traditional data center computing environment and a virtual asset computing environment, or other kinds of computing environments, according to one embodiment.

The service provider computing environment 110 includes an electronic document preparation system 111, which is configured to provide electronic document preparation services to a user.

According to one embodiment, the electronic document preparation system 111 can be a system that assists in preparing financial documents related to one or more of tax return preparation, invoicing, payroll management, billing, banking, investments, loans, credit cards, real estate investments, retirement planning, bill pay, and budgeting. The electronic document preparation system 111 can be a standalone system that provides financial document preparation services to users. Alternatively, the electronic document preparation system 111 can be integrated into other software or service products provided by a service provider.

In many situations, such as in tax return preparation situations, state and federal governments or other financial institutions issue new or updated versions of standardized forms each year or even several times within a single year. Each time a new form is released, the electronic document preparation system 111 may need to generate new processes for calculating the data values for the new form. Additionally, even in cases in which a form has not changed, and electronic document preparation system they nevertheless wish to update the process for calculating the data values for the new form to improve the efficiency or accuracy of the process. If the electronic forms are not correctly completed, there can be serious consequences for users. Thus, the electronic document preparation system 111 in accordance with principles of the present disclosure advantageously generates a training set for testing the new calculation that results in an efficient and accurate testing process.

According to one embodiment, the electronic document preparation system 111 receives new calculation data corresponding to a new process for calculating data values for an electronic document. The electronic document preparation system 111 identifies the variables associated with the new calculation data. The electronic document preparation system retrieves historical user data associated with historical users of the electronic document preparation system 111. The electronic document preparation system 111 divides the historical users into groups based on the combinations of data values of the historical users for the various variables associated with the new calculation data. The electronic document preparation system 111 selects the groups such that sampling a few historical users from each group will ensure that both common and rare types of historical users will be included in the training set data. This results in sampled training set data that includes historical user data related to a relatively small number of historical users that nevertheless includes historical user data with rare but important data values. In this way, when new calculation data is tested, the test data can be generated from the historical user data associated with a relatively small number of historical users.

The electronic document preparation system 111 includes a new code database 112, a prior code database 114, a data acquisition module 116, a summary data generation module 118, a sampling module 120, a testing module 126, and an interface module 128, according to various embodiments.

In one embodiment, the electronic document preparation system 111 also includes computing resources 122. The computing resources 122 include processing resources 130 and memory resources 132. The processing resources 130 can include one or more processors. The memory resources 132 can include one or more memories configured as computer readable media capable of storing software instructions and other data. The processing resources 130 are capable of executing software instructions stored on the computer readable media. The various components, modules, databases, and engines of the electronic document preparation system 111 can utilize the computing resources 122 to assist in performing their various functions. Alternatively, or additionally, the various components, modules, databases, and engines can utilize other computing resources.

In one embodiment, the new code database 112 includes new calculation data 140. The new calculation data 140 includes one or more new calculations for calculating data values associated with an electronic document that the electronic document preparation system 111 will assist users to prepare. The new code database 112 can include a large number of candidate new calculations for preparing various parts of an electronic document.

In one embodiment, the new calculation data 140 includes a new calculation for generating data values for a form associated with an electronic document that the electronic document preparation system 111 assists users to prepare. A single electronic document may include or utilize a large number of forms. Some of the forms may be a part of the electronic document. Other forms may be utilized by the electronic document preparation system 111 to merely assist in preparing the electronic document. For example, some forms include worksheets for generating data values utilized in another form or portion of the electronic document. The new calculation data 140 can include a new calculation for generating a data value associated with a form, or for generating multiple or all of the data values associated with a form. Thus, a single calculation from the new calculation data 140 can correspond to a process for populating an entire form or for populating a portion of a form.

In one embodiment, the new calculation data 140 includes variable data 142. The variable data 142 corresponds to variables associated with a calculation. In one example, the new calculation data 140 includes a calculation for generating a particular data value for a particular form. The calculation can include multiple variables that correspond to data values or attributes associated with the user that can be collected from the user as part of an electronic document preparation interview. In another example, the new calculation data 140 includes a calculation for populating many data fields of a form. The variable data 142 can include all of the variables associated with all the data fields of the form.

In one embodiment, the variable data 142 related to a particular calculation can include many kinds of variables. The variables can include answers to yes or no questions, monetary values that can fall within a large range, nonmonetary number values, an integer that can fall within a range of integers, whether or not the user has checked a box or made a particular selection, or other kinds of variables. The variable data 142 related to a particular calculation can include multiple of these different types of variables.

In one embodiment, the electronic document preparation system 111 is a tax return preparation system. In this case, the new calculation data 140 can include a new process for calculating data values for many data fields or lines of a tax form. A single data field or line may depend on variables such as a user's gross income, a user's age, a number of dependents, taxes withheld, whether or not the user is a veteran, whether or not the user is a homeowner, whether or not a user has elected a particular tax preparation feature, data values from a separate tax worksheet, data values from a separate tax form, or many other kinds of tax related variables. Thus, the calculation associated with the new calculation data 140 can include a large number of variables whose values may be provided by the user, obtained from the user, calculated in a different tax form, etc. The variable data 142 associated with a particular tax related calculation identifies the tax related variables related to that calculation.

In one embodiment, the electronic document preparation system 111 retains the prior code data 144, at least in part, in order to be able to test new calculations and processes for preparing electronic documents. As set forth previously, the new calculation data 140 may include a new process or calculation for populating a form associated with an electronic document. The form itself and its requirements may be identical or similar to the requirements for that same form at a time when the prior code data was utilized by the electronic document preparation system 111 to prepare electronic documents. In this case, the prior code data 144 can be used as a basis for comparison to determine if the new calculation data is accurate. If the prior code data was known to be accurate, and the new calculation data 140 provides the same data values for the same historical users as the prior code data, then the new calculation data 140 can be determined to be accurate. Thus, in one embodiment, the prior code database 114 retains the prior code data 144 for testing purposes.

In one embodiment, the prior code database 114 retains the prior code data 144 because the electronic document preparation system still uses the prior code data 144. In this case, the prior code data 144 is also the current code used by the electronic document preparation system to prepare electronic documents for users of the electronic document preparation system 111 until new calculations can be devised, tested, and implemented.

In one embodiment, the electronic document preparation system 111 uses the data acquisition module 116 to gather or retrieve historical user data 146. The historical user data 146 includes previously prepared documents for a large number of previous users of the electronic document preparation system 111. The historical user data 146 includes data values and attributes related to each of the historical users. The data values and attributes can include data provided by the user, data obtained from the user, data related to the user and obtained from third-party sources, and data generated by the electronic document preparation system 111. The historical user data 146 includes all of the related data used to prepare electronic documents for the historical users. Thus, the historical user data 146 includes data values for all of the variables associated with all of the data values for the lines of the various forms associated with the previously prepared documents.

In one embodiment, the historical user data 146 can include previously prepared electronic documents which were filed with or approved by a government or other institution. In this way, the historical user data 146 can be assured in large part to be accurate and properly prepared, though some of the previously prepared documents will inevitably include errors. The historical user data 146 can be utilized in testing the accuracy of the new calculation data 140 as will be set forth in more detail below.

In one embodiment, the electronic document preparation system 111 is a financial document preparation system. In this case, the historical user data 146 can include historical financial data. The historical financial data can include, for each historical user of the electronic document preparation system 111, information, such as, but not limited to, a name of the user, a name of the user's employer, an employer identification number (EID), a job title, annual income, salary and wages, bonuses, a Social Security number, a government identification, a driver's license number, a date of birth, an address, a zip code, home ownership status, marital status, W-2 income, an employer's address, spousal information, children's information, asset information, medical history, occupation, information regarding dependents, salary and wages, interest income, dividend income, business income, farm income, capital gain income, pension income, IRA distributions, education expenses, health savings account deductions, moving expenses, IRA deductions, student loan interest, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, in a financial document preparation system or in the preparation of financial documents such as a user's tax return, according to various embodiments.

In one embodiment, the data acquisition module 116 is configured to obtain or retrieve historical user data 146 from a large number of sources. The data acquisition module 116 can retrieve, from databases of the electronic document preparation system 111, historical user data 146 that has been previously obtained by the electronic document preparation system 111 from a plurality of third-party institutions. Additionally, or alternatively, the data acquisition module 116 can retrieve the historical user data 146 afresh from the third-party institutions.

In one embodiment, the data acquisition module 116 can also supply or supplement the historical user data 146 by gathering pertinent data from other sources including third party computing environments, public information computing environments, the additional service provider systems 180, data provided from historical users, data collected from user devices or accounts of the electronic document preparation system 111, social media accounts, or various other sources to merge with or supplement historical user data 146, according to one embodiment.

The data acquisition module 116 can gather additional data including historical financial data and third-party data. For example, the data acquisition module 116 is configured to communicate with additional service provider systems 180, e.g., a tax return preparation system, a payroll management system, or other electronic document preparation system, to access financial data 182, according to one embodiment. The data acquisition module 116 imports relevant portions of the financial data 182 into the electronic document preparation system 111 and, for example, saves local copies into one or more databases, according to one embodiment.

In one embodiment, the additional service provider systems 180 include a personal electronic document preparation system, and the data acquisition module 116 is configured to acquire financial data 182 for use by the electronic document preparation system 111 in learning and incorporating the new or updated form into the electronic document preparation system 111. Because the service provider provides both the electronic document preparation system 111 and, for example, the additional service provider systems 180, the service provider computing environment 110 can be configured to share financial information between the various systems. By interfacing with the additional service provider systems 180, the data acquisition module 114 can supply or supplement the historical user data 146 from the financial data 182. The financial data 182 can include income data, investment data, property ownership data, retirement account data, age data, data regarding additional sources of income, marital status, number and ages of children or other dependents, geographic location, and other data that indicates personal and financial characteristics of users of other financial systems, according to one embodiment.

In one embodiment, the electronic document preparation system 111 utilizes the summary data generation module 118 to generate summary data 148. In particular, when new calculation data 140 is to be tested, the summary data generation module 118 retrieves the variable data 142 related to the new calculation data 140 in order to identify what data items from the historical user data 146 will be needed to generate the summary data 148. The summary data generation module 118 retrieves the historical user data 146 from the data acquisition module 116 and generates the summary data 148 by analyzing the historical user data 146 for large number of historical users. The summary data 148 is utilized by the electronic document preparation system 111 to assist in identifying a training set for testing the new calculation data 140.

In one embodiment, the summary data 148 includes bin data 150. The bin data 150 includes, for each variable from the variable data 142 associated with the new calculation data 140, a plurality of bins. For a given variable, each bin associated with that variable corresponds to a value or a range of values for that variable that occurs within the historical user data 146. Therefore, the summary data generation module 118 generates the bin data 150 based on an analysis of the historical user data 146. The summary data generation module 118 analyzes, for a large number of historical users, the data values that those historical users have for the variables. The summary data generation module 118 then identifies bins that will be associated with those variables. For each variable, each historical user of the historical user data 146 will be sorted into one of the bins associated with that variable based on the data value of the variable for that historical user.

In one embodiment, a variable may correspond to a yes or no value. In this case, the summary data generation module 118 generates only two bins for that variable. A first bin is for a data value of yes. A second bin is for a data value of no. Historical users that have a data value of yes for that variable will be sorted into the first bin. Historical users that have a data value of no for that variable will be sorted into the second bin. Thus, for the yes or no variable, each historical user will either be sorted into the yes bin or the no bin. In some cases, the summary data generation module 118 may generate a third bin for those historical users that provided no value for the yes or no variable. In this case, historical users that did not have a value for the yes or no variable will be sorted into the third bin.

In one embodiment, a variable may correspond to a checkbox that the user may either check or not check during an electronic document preparation interview or while filling out a form associated with the electronic document. In this case, the summary data generation module 118 generates two bins for that variable. A first bin is for historical users that checked the checkbox. A second bin is for historical users that did not check the checkbox. The historical users are then sorted into either the first or the second bin.

In one embodiment, a variable may correspond to an amount of money. There may be a large distribution of data values for that variable among the historical users. In this case, the summary data generation module 118 may generate several bins based on the statistical distribution of data values. There may be a bin for negative values, a bin for a zero value, a bin for a null value, and several bins for various ranges of positive values. The summary data generation module 118 generates bins for statistically distinct ranges of values. The summary data generation module 118 generates these bins so that uncommon value ranges have their own bins, while common value ranges also have their own bins.

In an example in which a variable corresponds to an amount of money, the summary data generation module may determine that a large proportion of historical users have a value between $3000 and $5000. A smaller proportion the historical users have a value between $2000 and $2999. A very small proportion of historical users have a value between $1 and $1999. Another very small proportion of the historical users of a value greater than $5000. In this case, the summary data generation module 118 may generate four bins for this variable in accordance with the ranges set forth above. As discussed above, in many cases, even though very few historical users fall between $1 and $1999 or above $5000, it is nevertheless important to have bins that represent the small but distinct groups.

In one embodiment, the summary data generation module 118 can generate the bin data 150 for a variable that includes distributions of historical users across a large number of possible values by utilizing statistical techniques. In one embodiment, the summary data generation module 118 may generate a histogram that indicates the number of historical users with each value of the variable. The summary data generation module 118 may initially generate a bin for each value. The summary data generation module 118 may then begin to merge adjacent bins if the densities of those bins are very similar. The density of the bins corresponds to the range of the bin divided by the number of historical users that fit in the bin. Adjacent bins that have distinct densities, as determined in accordance with internal parameters of the summary data generation module 118, are not merged together. When bins cannot be merged further, the remaining bins makeup the final bins for the bin data 150.

In one embodiment, the summary data generation module 118 can generate the bin data 150 based on other statistical considerations. For example, the summary data generation module 118 can generate bins based on threshold proportions of historical users that determine ranges of users. These thresholds can include standard deviations, thresholds selected by experts that administrate or manage the summary data generation module 118, or the summary data generation module 118 can select its own thresholds for generating bins.

In one embodiment, a variable may correspond to a number, such as a positive integer. One example of such a variable is a number of allowances claimed in a tax return. The summary data generation module 118 may analyze the historical user data 146 and may determine that there should be a bin for 0 allowances, a bin for 1 allowance, a bin for 2-4 allowances, and a bin for 5 or more allowances based on the statistical distribution of data values for this variable among the historical users.

In one embodiment, the summary data 148 includes grouping data 152. The grouping data 152 corresponds to groups of historical users based on how they are distributed among the bins for the various variables. Because each historical user is sorted into one of the bins associated with each variable, each historical user can be represented by the combination of bins with which the historical users are associated. The summary data generation module 118 generates the grouping data 152 including groups of historical users based on the combinations of bins with which they are associated.

In one embodiment, the summary data generation module 118 generates a group in the grouping data 152 for each unique combination of bins associated with the historical users. A large number of users may be represented by a particular combination of bins. Other combinations of bins may represent smaller numbers of users. Because there is a group for each unique combination of bins, there are groups for users with very common combinations of attributes and there are groups for users with very uncommon combinations of attributes.

In one example, new calculation data 140 for a particular form includes variable data 142 that associates four variables with the calculation. The summary data generation module 118 generates summary data 148 that includes bin data 150 for the historical user data 146 associated with the four variables. The bin data includes two bins for the first variable, two bins for the second variable, three bins for the fourth variable, and five bins for the third variable. The number of possible combinations for these bins is 60. However, when the historical users are sorted into the bins based on their data values included in the historical user data 146, the summary data generation module 118 finds that only 20 of these possible combinations are represented by actual historical users. The summary data generation module 118 generates grouping data 152 that includes a group for each of the 20 combinations of bins represented by the historical users.

In one embodiment, the sampling module 120 generates sampling data 154 by selecting historical users from the groups in the grouping data 152. The sampling module 120 can sample a selected number of historical users from each group of historical users from the grouping data 152. The sampling data 154 includes historical users representing every unique combination of the bins of the bin data 150 for the variables from the variable data 142.

In one embodiment, the sampling module 120 generates sampling data 154 by selecting a relatively small number of historical users from each group represented by the grouping data 152. Even though a small number of historical users are sampled, the portion of the historical user data 146 represented by the sampling data 154 is highly effective for testing the new calculation data 140 because the sampling data 154 includes historical users from each group represented by the grouping data 152. The groups in the grouping data 152 are selected so that some groups include uncommon combinations of data values or extreme combinations of data values. Thus, while the sample size may be small, the sampling is ensured to include both rare and common combinations of data values because samples are taken from each group.

In one embodiment, the sampling module 120 generates the training set data 156. The training set data 156 includes the historical user data 146 related to the historical users selected in the sampling data.

In one embodiment, some groups defined by the grouping data 152 may be very small. In the cases of very small groups, the sampling module 120 may generate sampling data 154 that includes every historical user in the very small groups. These groups could include fewer than 10 historical users, or even only a single historical user. In these cases, the sampling data 154 may include every historical user in the group.

In one embodiment, the testing module 126 is configured to test the new calculation data 140 to determine the accuracy of the new calculation data 140. The testing module 126 receives the new calculation data 140 from the new code database 112. The testing module 126 receives the training set data 156 from the sampling module 120. The training set data includes those portions of the historical user data 146 associated with the historical users identified in the sampling data 154. The training set data 156 can also be considered to include the previously prepared electronic documents identified in the sampling data 154 and all of the data associated with the previously prepared documents. The testing module 126 then executes the new calculation data 140 with the data values from training set data 156 associated with the variable data 142. The execution of the new calculation data 140 generates test data. The test data corresponds to those data values that that are generated by the new calculation data 140 based on the data values of the variables from the training set data 156 associated with the variable data 142. The testing module 126 then generates results data 166 by comparing the test data 164 to the corresponding data values from the training set data. If the test data matches the corresponding data values from the results data 166 indicates how closely the test data 164 matches the corresponding data values from the training set data 156.

Using the disclosed embodiments of a method and system for generating efficient training sets for testing new processes for preparing electronic documents for users of an electronic document preparation system, a method and system for generating efficient training sets for testing new processes for preparing electronic documents for users of an electronic document preparation system more accurately is provided. Therefore, the disclosed embodiments provide a technical solution to the long standing technical problem of efficiently and accurately testing new calculations or processes in an electronic document preparation system.

In addition, the disclosed embodiments of a method and system for generating efficient training sets for testing new processes for preparing electronic documents for users of an electronic document preparation system are also capable of dynamically adapting to constantly changing fields such as tax return preparation and other kinds of document preparation. Consequently, the disclosed embodiments of a method and system for generating efficient training sets for testing new processes for preparing electronic documents for users of an electronic document preparation system also provide a technical solution to the long standing technical problem of static and inflexible electronic document preparation systems.

The result is a much more accurate, adaptable, and robust method and system for generating efficient training sets for testing new processes for preparing electronic documents for users of an electronic document preparation system. This, in turn, results in: less human and processor resources being dedicated to analyzing new forms because more accurate and efficient analysis methods can be implemented, i.e., usage of fewer processing resources, usage of fewer memory storage assets, and less communication bandwidth being utilized to transmit data for analysis.

### Process

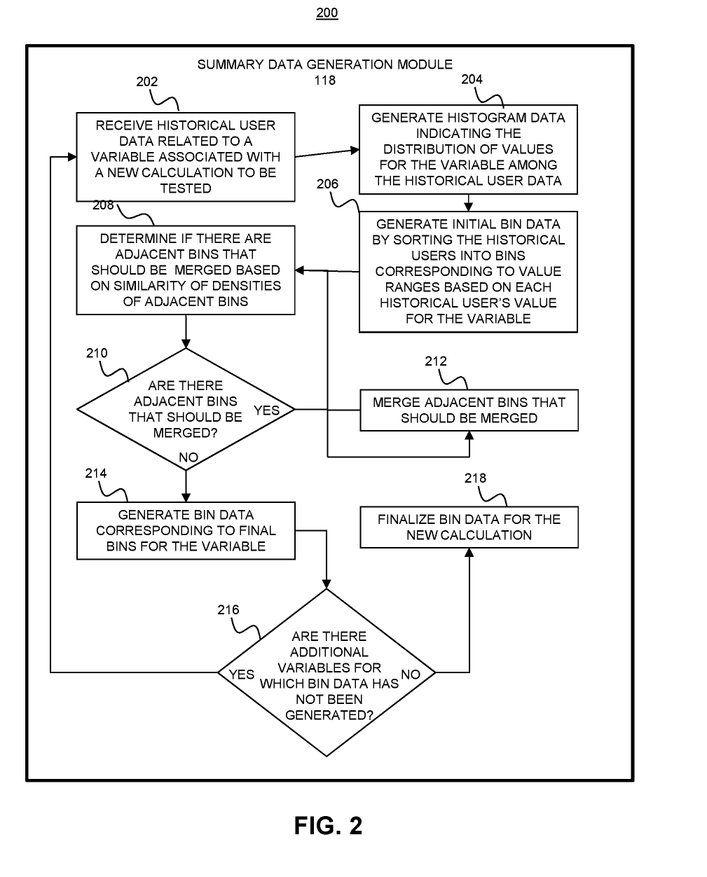

FIG. 2 is a block diagram of a process 200 for generating bin data as precursor to generating training set data, according to one embodiment.

With reference to FIG. 2 and FIG. 1, at block 202 the summary data generation module 118 receives historical user data related to a variable associated with a new calculation to be tested for an electronic document preparation system, according to one embodiment. The historical data corresponds to historical data for a large number of historical users of the electronic document preparation system. The historical data includes, for each historical user, a value for the variable. From block 202, the process proceeds to block 204.

At block 204 the summary data generation module 118 generates histogram data indicating the distribution of values for the variable among the historical user data, according to one embodiment. The histogram data can indicate each value for the variable that is found among the historical user data as well as the number of historical users who have that value. Alternatively, the summary data generation module 118 can generate a representation of the distribution of values for the variable in a form other than a histogram. From block 204, the process proceeds to block 206.

At block 206 the summary data generation module 118 generates initial bin data by sorting the historical users into bins corresponding to value ranges based on each historical user's value for the variable. Alternatively, the initial bin data can include a bin for each value for the variable found among the historical user data. From block 206, the process proceeds to block 208.

At block 208, the summary data generation module 118 determines if there are adjacent bins that should be merged based on similarity in densities of the adjacent bins, according to one embodiment. In one embodiment, the density of a bin corresponds to the number of historical users assigned to the bin, divided by the width of the bin. In one embodiment, the width of the bin corresponds to the range of values included in the bin. In one embodiment, the summary data generation module 118 can determine if there are adjacent bins that should be merged together based on rules defined in one or more algorithms. The rules can include statistical rules for defining and merging bins. The rules can indicate a range of ratios of densities between two adjacent bins that should result in the merging of those bins. Alternatively, the rules can include other statistical bases for defining bins. Such other statistical bases can include standard deviations, percentages of historical users that fall in various ranges, threshold values, or other statistical considerations that can ensure that there are bins corresponding to each range of rare and common values for the variable. From block 208, the process proceeds to block 210.

At block 210, if there are bins that should be merged based on the determination made at block 208, then the process proceeds to block 212. At block 212, the summary data generation module 118 merges adjacent bins that should be merged in accordance with the determination made at block 208, according to one embodiment. This results in a smaller number of bins, because some adjacent bins have been merged together to form a new bin that includes the ranges of all the bins that were merged together to form the new bin. The new bin includes all of the historical users that were included in the bins that were merged together to form the new bin. If the bins were merged based on similarities in densities, then the resulting bin should have a density that is similar or identical to the densities of the bins that were merged together to form the new bin. From block 212, the process returns to block 208.

At block 208 the summary data generation module 118 again determines if there are adjacent bins that should be merged based on similarity of densities of adjacent bins, or based on other statistical rules. At block 210, if there are bins that should be merged based on the determination made at block 208, then the process proceeds to block 212. At block 210, if there are no adjacent bins that should be merged based on the determination made in block 208, then the process proceeds to block 214.

At block 214, the summary data generation module 118 generates bin data corresponding to final bins for the variable, according to one embodiment. The finalized bin data includes a plurality of bins for the variable, with each historical user being sorted into one of the bins. From block 214, the process proceeds to block 216.

At block 216, the summary data generation module 118 determines whether or not there are additional variables for which bin data has not yet been generated, according to one embodiment. If there are additional variables for which bin data has not been generated, then the process returns to block 202, at which point historical user data is received for the next variable associated with the new calculation to be tested. The process proceeds through the blocks and generates bin data for the new variable. At block 216, if there are no additional variables for which bin data has not been generated, then the process proceeds to block 218.

At block 218, the summary data generation module 118 finalizes the bin data for all of the variables of the new calculation, according to one embodiment. The finalized bin data includes, for each variable, a plurality of bins. For each variable, each historical user is sorted into one of the bins associated with the variable. Thus, each historical user can be represented by the combination of bins into which the historical user has been sorted for the new calculation to be tested.

Those of skill in the art will recognize, in light of the present disclosure, that different process steps and different orders of process steps can be implemented in accordance with principles of the present disclosure. All such other different process steps in different orders process steps fall within the scope of the present disclosure.

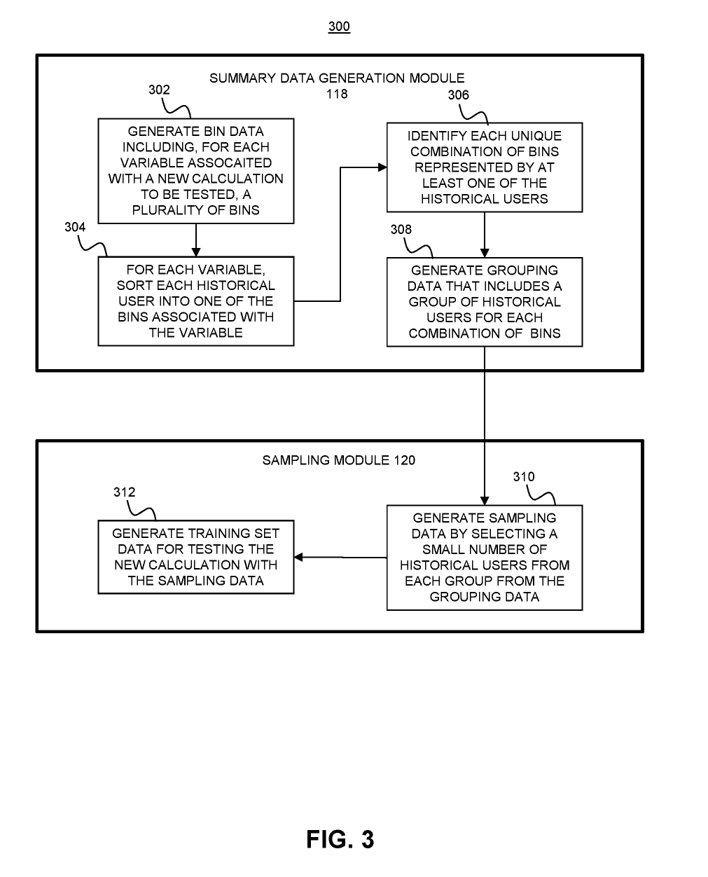

FIG. 3 is a block diagram of a process 300 for generating grouping data and training set data, according to one embodiment.

With reference to FIG. 3 and FIG. 1, at block 302, the summary data generation module 118 generates bin data including, for each variable associated with a new calculation to be tested, a plurality of bins, according to one embodiment. From block 302, the process proceeds to block 304.

At block 304, the summary data generation module 118, for each variable, sorts each historical user into one of the bins associated with the variable, according to one embodiment. Thus, each historical user can be represented by the combination of bins into which the historical user has been sorted for the several variables. From block 304, the process proceeds to block 306.

At block 306 the summary data generation module 118 identifies each unique combination of bins represented by at least one of the historical users, according to one embodiment. From block 306, the process proceeds to block 308.

At block 308, the summary data generation module 118 generates grouping data that includes a group of historical users for each combination of bins, according to one embodiment. It is possible that many historical users will have the same combination of bins. It is possible that some combinations of bins will be represented by only a single historical user. Thus, some groups from the grouping data may include only a single user, while other groups may have a very large number of historical users. From block 308, the process proceeds to block 310.

At block 310, the sampling module 120 generates sampling data by selecting a small number of historical users from each group from the grouping data. Because there is a group for each combination of bins represented by the historical users, even very rare combinations of values will be represented in the sampling data. From block 310, the process proceeds to block 312.

At block 312, the sampling module 120 generates training set data for testing the new calculation with the sampling data, according to one embodiment. In one embodiment, the training set data may simply be the sampling data. In one embodiment, the training set data may correspond to the sampling data with some further processing for implementing the training set data in a testing procedure.

Those of skill in the art will recognize, in light of the present disclosure, that different process steps and different orders of process steps can be implemented in accordance with principles of the present disclosure. All such other different process steps in different orders process steps fall within the scope of the present disclosure.

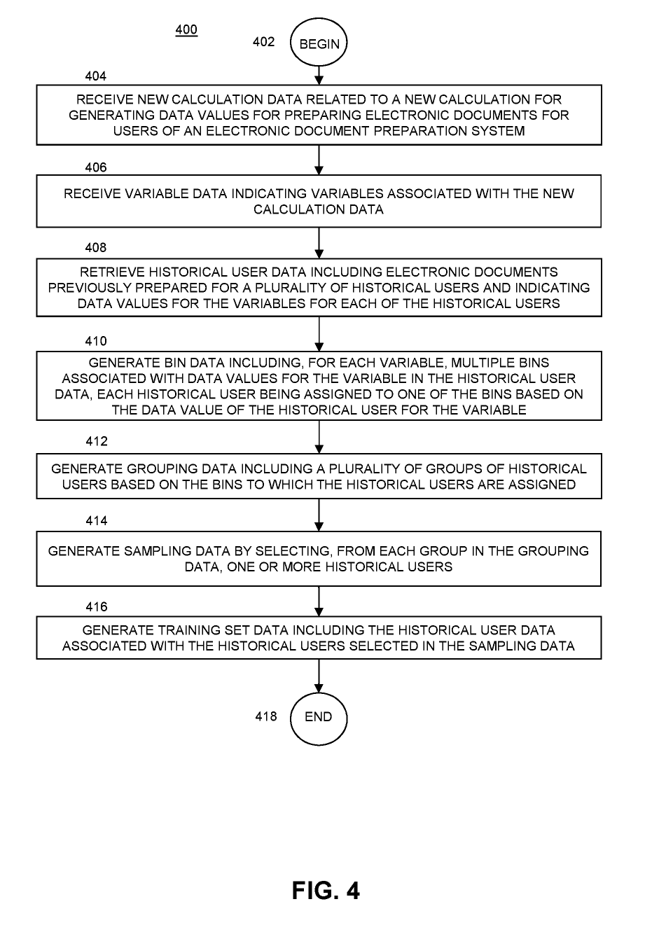

FIG. 4 illustrates a flow diagram of a process 400 for generating efficient training sets for testing new processes for preparing electronic documents for users of an electronic document preparation system, in various embodiments.

In one embodiment, process 400 begins at BEGIN 402 and process flow proceeds to RECEIVE NEW CALCULATION DATA RELATED TO A NEW CALCULATION FOR GENERATING DATA VALUES FOR PREPARING ELECTRONIC DOCUMENTS FOR USERS OF AN ELECTRONIC DOCUMENT PREPARATION SYSTEM 404.

In one embodiment, at RECEIVE NEW CALCULATION DATA RELATED TO A NEW CALCULATION FOR GENERATING DATA VALUES FOR PREPARING ELECTRONIC DOCUMENTS FOR USERS OF AN ELECTRONIC DOCUMENT PREPARATION SYSTEM 404, new calculation data is received related to a new calculation for generating data values for preparing electronic documents for users of an electronic document preparation system.

In one embodiment, once new calculation data is received related to a new calculation for generating data values for preparing electronic documents for users of an electronic document preparation system at RECEIVE NEW CALCULATION DATA RELATED TO A NEW CALCULATION FOR GENERATING DATA VALUES FOR PREPARING ELECTRONIC DOCUMENTS FOR USERS OF AN ELECTRONIC DOCUMENT PREPARATION SYSTEM 404 process flow proceeds to RECEIVE VARIABLE DATA INDICATING VARIABLES ASSOCIATED WITH THE NEW CALCULATION DATA 406.

In one embodiment, at RECEIVE VARIABLE DATA INDICATING VARIABLES ASSOCIATED WITH THE NEW CALCULATION DATA 406, variable data is received indicating variables associated with the new calculation data.

In one embodiment, once variable data is received indicating variables associated with the new calculation data at RECEIVE VARIABLE DATA INDICATING VARIABLES ASSOCIATED WITH THE NEW CALCULATION DATA 406, process flow proceeds to RETRIEVE HISTORICAL USER DATA INCLUDING ELECTRONIC DOCUMENTS PREVIOUSLY PREPARED FOR A PLURALITY OF HISTORICAL USERS AND INDICATING DATA VALUES FOR THE VARIABLES FOR EACH OF THE HISTORICAL USERS 408.

In one embodiment, at RETRIEVE HISTORICAL USER DATA INCLUDING ELECTRONIC DOCUMENTS PREVIOUSLY PREPARED FOR A PLURALITY OF HISTORICAL USERS AND INDICATING DATA VALUES FOR THE VARIABLES FOR EACH OF THE HISTORICAL USERS 408, historical user data is received including electronic documents previously prepared for a plurality of historical users and indicating data values for the variables for each of the historical users.

In one embodiment, once historical user data is received including electronic documents previously prepared for a plurality of historical users and indicating data values for the variables for each of the historical users at RETRIEVE HISTORICAL USER DATA INCLUDING ELECTRONIC DOCUMENTS PREVIOUSLY PREPARED FOR A PLURALITY OF HISTORICAL USERS AND INDICATING DATA VALUES FOR THE VARIABLES FOR EACH OF THE HISTORICAL USERS 408, process flow proceeds to GENERATE BIN DATA INCLUDING, FOR EACH VARIABLE, MULTIPLE BINS ASSOCIATED WITH DATA VALUES FOR THE VARIABLE IN THE HISTORICAL USER DATA, EACH HISTORICAL USER BEING ASSIGNED TO ONE OF THE BINS BASED ON THE DATA VALUE OF THE HISTORICAL USER FOR THE VARIABLE 410.

In one embodiment, at GENERATE BIN DATA INCLUDING, FOR EACH VARIABLE, MULTIPLE BINS ASSOCIATED WITH DATA VALUES FOR THE VARIABLE IN THE HISTORICAL USER DATA, EACH HISTORICAL USER BEING ASSIGNED TO ONE OF THE BINS BASED ON THE DATA VALUE OF THE HISTORICAL USER FOR THE VARIABLE 410, bin data is generated including, for each variable, multiple bins associated with data values for the variable in the historical user data, each historical user being assigned to one of the bins based on the data value of the historical user for the variable.

In one embodiment, once bin data is generated including, for each variable, multiple bins associated with data values for the variable in the historical user data, each historical user being assigned to one of the bins based on the data value of the historical user for the variable at GENERATE BIN DATA INCLUDING, FOR EACH VARIABLE, MULTIPLE BINS ASSOCIATED WITH DATA VALUES FOR THE VARIABLE IN THE HISTORICAL USER DATA, EACH HISTORICAL USER BEING ASSIGNED TO ONE OF THE BINS BASED ON THE DATA VALUE OF THE HISTORICAL USER FOR THE VARIABLE 410, process flow proceeds to GENERATE GROUPING DATA INCLUDING A PLURALITY OF GROUPS OF HISTORICAL USERS BASED ON THE BINS TO WHICH THE HISTORICAL USERS ARE ASSIGNED 412.

In one embodiment, at GENERATE GROUPING DATA INCLUDING A PLURALITY OF GROUPS OF HISTORICAL USERS BASED ON THE BINS TO WHICH THE HISTORICAL USERS ARE ASSIGNED 412, grouping data is generated including a plurality of groups of historical users based on the bins to which the historical users are assigned.

In one embodiment, once grouping data is generated including a plurality of groups of historical users based on the bins to which the historical users are assigned at GENERATE GROUPING DATA INCLUDING A PLURALITY OF GROUPS OF HISTORICAL USERS BASED ON THE BINS TO WHICH THE HISTORICAL USERS ARE ASSIGNED 412, process flow proceeds to GENERATE SAMPLING DATA BY SELECTING, FROM EACH GROUP IN THE GROUPING DATA, ONE OR MORE HISTORICAL USERS 414.

In one embodiment, at GENERATE SAMPLING DATA BY SELECTING, FROM EACH GROUP IN THE GROUPING DATA, ONE OR MORE HISTORICAL USERS 414, sampling data is generated by selecting, from each group in the grouping data, one or more historical users.

In one embodiment, once sampling data is generated by selecting, from each group in the grouping data, one or more historical users at GENERATE SAMPLING DATA BY SELECTING, FROM EACH GROUP IN THE GROUPING DATA, ONE OR MORE HISTORICAL USERS 414, process flow proceeds to GENERATE TRAINING SET DATA INCLUDING THE HISTORICAL USER DATA ASSOCIATED WITH THE HISTORICAL USERS SELECTED IN THE SAMPLING DATA 416.

In one embodiment, at GENERATE TRAINING SET DATA INCLUDING THE HISTORICAL USER DATA ASSOCIATED WITH THE HISTORICAL USERS SELECTED IN THE SAMPLING DATA 416, training set data is generated including the historical user data associated with the historical users selected in the sampling data.

In one embodiment, once training set data is generated including the historical user data associated with the historical users selected in the sampling data at GENERATE TRAINING SET DATA INCLUDING THE HISTORICAL USER DATA ASSOCIATED WITH THE HISTORICAL USERS SELECTED IN THE SAMPLING DATA 416, process flow proceeds to END 418.

In one embodiment, at END 418 the process 400 for generating efficient training sets for testing new processes for preparing electronic documents for users of an electronic document preparation system is exited to await new data and/or instructions.

As noted above, the specific illustrative examples discussed above are but illustrative examples of implementations of embodiments of the method or process for generating efficient training sets for testing new processes for preparing electronic documents for users of an electronic document preparation system. Those of skill in the art will readily recognize that other implementations and embodiments are possible. Therefore, the discussion above should not be construed as a limitation on the claims provided below.

In one embodiment, a system generates efficient training sets for testing new processes for preparing electronic documents for users of an electronic document preparation system. The system includes at least one processor and at least one memory coupled to the at least one processor. The at least one memory has stored therein instructions which, when executed by any set of the one or more processors, perform a process. The process includes receiving new calculation data related to a new calculation for generating data values for preparing electronic documents for users of an electronic document preparation system and receiving variable data indicating variables associated with the new calculation data. The process includes retrieving historical user data including electronic documents previously prepared for a plurality of historical users and indicating data values for the variables for each of the historical users. The process includes generating bin data including, for each variable, multiple bins associated with data values for the variable in the historical user data. Each historical user is assigned to one of the bins based on the data value of the historical user for the variable. The process includes generating grouping data including a plurality of groups of historical users based on the bins to which the historical users are assigned, generating sampling data by selecting, from each group in the grouping data, one or more historical users, and generating training set data including the historical user data associated with the historical users selected in the sampling data.

In one embodiment, an electronic document preparation system includes a new code database configured to store new calculation data related to a new calculation for generating data values for preparing electronic documents for users of the electronic document preparation system. The new calculation data includes variable data indicating variables associated with the new calculation data. The system includes a data acquisition module configured to gather historical user data including electronic documents previously prepared for a plurality of historical users and indicating data values for the variables for each of the historical users. The system includes a summary data generation module configured to generate summary data by generating bin data including, for each variable, multiple bins associated with data values for the variable in the historical user data. Each historical user is assigned to one of the bins based on the data value of the historical user for the variable. The summary data includes grouping data, the grouping data includes, for each combination of bins represented among the historical users, a group of historical users that correspond to the combination of bins. The system includes a sampling module configured to generate sampling data by selecting, from each group in the grouping data, one or more historical users.

In one embodiment, a computing system implemented method for generating efficient training sets for testing new processes for preparing electronic documents for users of an electronic document preparation system, includes receiving new calculation data related to a new calculation for generating data values for preparing electronic documents for users of an electronic document preparation system. The method includes retrieving historical user data including electronic documents previously prepared for a plurality of historical users. The method includes receiving variable data indicating variables associated with the new calculation data, the historical user data indicating data values for the variables for each of the historical users. The method includes generating bin data including, for each variable, multiple bins associated with data values for the variable in the historical user data. Each historical user is assigned to one of the bins based on the data value of the historical user for the variable. The method includes generating grouping data including a plurality of groups of historical users based on the bins to which the historical users are assigned. The method includes generating sampling data by selecting, from each group in the grouping data, one or more historical users. The method includes generating training set data including the historical user data associated with the historical users included in the sampling data.

In the discussion above, certain aspects of one embodiment include process steps, operations, or instructions described herein for illustrative purposes in a particular order or grouping. However, the particular orders or groupings shown and discussed herein are illustrative only and not limiting. Those of skill in the art will recognize that other orders or groupings of the process steps, operations, and instructions are possible and, in some embodiments, one or more of the process steps, operations and instructions discussed above can be combined or deleted. In addition, portions of one or more of the process steps, operations, or instructions can be re-grouped as portions of one or more other of the process steps, operations, or instructions discussed herein. Consequently, the particular order or grouping of the process steps, operations, or instructions discussed herein do not limit the scope of the invention as claimed below.

As discussed in more detail above, using the above embodiments, with little or no modification or input, there is considerable flexibility, adaptability, and opportunity for customization to meet the specific needs of various parties under numerous circumstances.

In the discussion above, certain aspects of one embodiment include process steps, operations, or instructions described herein for illustrative purposes in a particular order or grouping. However, the particular order or grouping shown and discussed herein are illustrative only and not limiting. Those of skill in the art will recognize that other orders and groupings of the process steps, operations, or instructions are possible and, in some embodiments, one or more of the process steps, operations, or instructions discussed above can be combined or deleted. In addition, portions of one or more of the process steps, operations, or instructions can be re-grouped as portions of one or more other of the process steps, operations, or instructions discussed herein. Consequently, the particular order or grouping of the process steps, operations, or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general-purpose system selectively activated or configured/reconfigured by a computer program stored on a computer program product as discussed herein that can be accessed by a computing system or another device.

Those of skill in the art will readily recognize that the algorithms and operations presented herein are not inherently related to any particular computing system, computer architecture, computer or industry standard, or any other specific apparatus. Various general-purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A system for generating efficient training sets for testing new processes for preparing electronic documents for users of an electronic document preparation system, the system comprising:
at least one processor; and
at least one memory coupled to the at least one processor, the at least one memory having stored therein instructions which, when executed by any set of the one or more processors, perform a process including:
receiving new calculation data related to a new calculation for generating data values for preparing electronic documents for users of an electronic document preparation system;
receiving variable data indicating variables associated with the new calculation data;
retrieving historical user data including electronic documents previously prepared for a plurality of historical users and indicating data values for the variables for each of the historical users;
generating bin data including, for each variable, multiple bins associated with data values for the variable in the historical user data, each historical user being assigned to one of the bins based on the data value of the historical user for the variable;
generating grouping data including a plurality of groups of historical users based on the bins to which the historical users are assigned;
generating sampling data by selecting, from each group in the grouping data, one or more historical users; and
generating training set data including the historical user data associated with the historical users selected in the sampling data.

2. The system of claim 1, wherein the grouping data includes a group for each unique combination of bins represented by at least one of the historical users.

3. The system of claim 1, wherein one or more of the groups includes only a single historical user.

4. The system of claim 1, wherein the sampling data includes only a single user from one or more of the groups.

5. The system of claim 1, wherein at least one of the variables is a Boolean variable and the bin data includes a bin for each possible value of the Boolean variable.

6. The system of claim 5, wherein the bin data includes a bin for a null value for the Boolean variable.

7. The system of claim 1, wherein at least one of the variables corresponds to a check box.

8. The system of claim 1, wherein at least one of the variables is a money value variable.

9. The system of claim 8, wherein the bin data for the money value variable includes one or more of:
a bin for a negative monetary value;
a bin for zero monetary value;
a bin for null value corresponding to no value present;
a bin for a positive monetary value;
multiple bins for multiple ranges of positive monetary values; and
multiple bins for multiple ranges of negative monetary values.

10. The system of claim 1, wherein at least one of the variables is a number value variable.

11. The system of claim 10, wherein the bin data for the number value variable includes one or more of:
a bin for a negative number value;
a bin for zero number value;
a bin for null value corresponding to no value present;
a bin for a positive number value;
multiple bins for multiple ranges of positive number values; and
multiple bins for multiple ranges of negative number values.

12. The system of claim 1, wherein at least one of the variables is an integer value variable.

13. The system of claim 1, wherein the bin data for the integer value variable includes one or more of:
a bin for a single integer value;
multiple bins for single integer values; and
a bin for a range of integer values.

14. The system of claim 1, wherein the electronic document preparation system is a tax return preparation system.

15. The system of claim 14, wherein the historical user data includes historical user tax related data, and wherein the previously prepared electronic documents are previously prepared tax returns.

16. The system of claim 15, wherein the new calculation data includes a calculation for a tax related form associated with a tax return.

17. The system of claim 16, wherein the variables include tax related variables.

18. The system of claim 1, wherein the process further includes testing the new calculation data by executing the new calculation data for the training set data.

19. The system of claim 18, wherein the process further includes:
generating results data indicating results of testing the new calculation data; and
outputting the results data.

20. The system of claim 1, wherein generating the bin data includes, for one of the variables:
generating a plurality of initial bins based on data values of the variable for the historical users;
selecting to merge or to not merge adjacent initial bins based on how similar the initial bins are to each other; and
generating the bins as those initial bins that remain after initial bins can no longer be merged.

21. The system of claim 20, wherein selecting to merge adjacent initial bins is based on how similar are the densities of the adjacent initial bins, wherein bin density corresponds to a number of historical users sorted into the initial bin divided by a width of the initial bin.

22. The system of claim 1, wherein, for one of the variables, value ranges of the bins are selected based on statistical analysis of data values of the variable for the historical users.

23. An electronic document preparation system, comprising:
a new code database configured to store new calculation data related to a new calculation for generating data values for preparing electronic documents for users of the electronic document preparation system, the new calculation data including variable data indicating variables associated with the new calculation data;
a data acquisition module configured to gather historical user data including electronic documents previously prepared for a plurality of historical users and indicating data values for the variables for each of the historical users;
a summary data generation module configured to generate summary data by generating bin data including, for each variable, multiple bins associated with data values for the variable in the historical user data, each historical user being assigned to one of the bins based on the data value of the historical user for the variable, the summary data including grouping data, the grouping data including, for each combination of bins represented among the historical users, a group of historical users that correspond to the combination of bins; and
a sampling module configured to generate sampling data by selecting, from each group in the grouping data, one or more historical users.

24. The system of claim 23, wherein the electronic document preparation system includes a testing module configured to test the new calculation data for each historical user represented in the sampling data and to generate results data indicating results of the test.

25. The system of claim 23, wherein the electronic document preparation system includes an interface module configured to output the results data.

26. A computing system implemented method for generating efficient training sets for testing new processes for preparing electronic documents for users of an electronic document preparation system, the method comprising:
receiving new calculation data related to a new calculation for generating data values for preparing electronic documents for users of an electronic document preparation system;
retrieving historical user data including electronic documents previously prepared for a plurality of historical users;
receiving variable data indicating variables associated with the new calculation data, the historical user data indicating data values for the variables for each of the historical users;
generating bin data including, for each variable, multiple bins associated with data values for the variable in the historical user data, each historical user being assigned to one of the bins based on the data value of the historical user for the variable
generating grouping data including a plurality of groups of historical users based on the bins to which the historical users are assigned;
generating sampling data by selecting, from each group in the grouping data, one or more historical users; and
generating training set data including the historical user data associated with the historical users included in the sampling data.

27. The method of claim 26, wherein generating the bin data includes, for each variable, generating a plurality of initial bins based on a distribution of data values for the variable in the historical user data.

28. The method of claim 27, wherein generating the bin data includes, for each variable, generating a histogram representing the distribution of data values for the variable in the historical user data.

29. The method of claim 27, wherein generating the bin data includes determining whether adjacent initial bins should be merged based on statistical rules.

30. The method of claim 29, wherein generating the bin data includes determining whether adjacent initial bins should be merged based similarities in density between adjacent initial bins.

31. The method of claim 30, wherein the density of an initial bin corresponds to a ratio of a number of historical users assigned to the initial bin to a range of data values assigned to the initial bin.

32. The method of claim 31, wherein generating the grouping data includes merging adjacent initial bins that have similar densities within a threshold difference or ratio.

33. The method of claim 29, wherein generating the bin data includes merging adjacent initial bins in multiple iterations until further merging is not allowed based on the statistical rules.

34. The method of claim 26, wherein the grouping data includes a group for each combination of bins represented among the historical users.
